(19) United States
(12) Patent Application Publication
(10) Pub. No.: US 2024/0304871 A1
(43) Pub. Date: Sep. 12, 2024

(54) Pender-Process

(71) Applicant: Leonard Lee Pendergrast, Etowah, TN (US)

(72) Inventor: Leonard Lee Pendergrast, Etowah, TN (US)

(21) Appl. No.: 18/445,024

(22) Filed: Mar. 9, 2023

(51) Int. Cl. H01M 10/12; H01M 10/08; H01M 10/44

(52) U.S. Cl. CPC H01M 10/12; H01M 10/08; H01M 10/44

(57) ABSTRACT

This is a process by which lead acid batteries may be restored to proper function after the plates have become sulfated.

### SUMMARY

The sulfuric acid electrolyte is altered with a sodium hydroxide catalyst.

### THE PENDER-PROCESS

This is a process by which a lead acid battery may be properly restored by the re-oxidization of the plates.
add sodium hydroxide approximately 2 mole solution approximately 1 cc per cell for small batteries and 2 cc per cell for larger batteries. Charge normally.

Statement: Nothing new has been added. I just deleted everything. The other method worked but this is the most effective method as described in the first application.

### BACKGROUND

Lead acid batteries are expensive and ecologically very bad. Lead is a potent toxin which poisons the ground until it leaches into our water supply and poisons us. There is a tremendous need for restoration.

1. I hereby claim that, my invention, the Pender-Process can induce sulfated lead acid batter[es to take a charge and restore them to proper function and extend the useful life of batteries through the inclusion the catalyst in standard electrolyte.
